(19) United States
(12) Patent Application Publication
(10) Pub. No.: US 2018/0229371 A1
(43) Pub. Date: Aug. 16, 2018

(54) METHOD AND DEVICE FOR PROVIDING AND HANDLING DIFFERENT COMPONENTS

(71) Applicant: EBZ Systec GmbH, Ravensburg (DE)

(72) Inventor: Rainer Stadler, Rast (DE)

(73) Assignee: EBZ Systec GmbH, Ravensburg (DE)

(21) Appl. No.: 15/935,343

(22) Filed: Mar. 26, 2018

Related U.S. Application Data
(63) Continuation of application No. PCT/EP2016/066464, filed on Jul. 12, 2016.

(30) Foreign Application Priority Data
Sep. 28, 2016 (DE) 10 2015 116 352.7

(51) Int. Cl. B25J 9/16; G05B 19/402; B23Q 17/22

(52) U.S. Cl. CPC B25J 9/1697; G05B 19/402; G05B 2219/50148; G05B 2219/31048; B23Q 17/22

(57) ABSTRACT

The present invention relates to a method for providing and handling different components. Furthermore, the invention relates to a device for providing and handling a quantity of different components comprising a depositing unit or a conveying unit, a manipulator and an image system. In this case, the image system comprises at least one projector, at least one image capturing unit and an image processing unit.

### CROSS REFERENCE TO RELATED APPLICATIONS

This application is a continuation of International Application No. PCT/EP2016/066464 filed Jul. 12, 2016, which designated the United States, and claims the benefit under 35 USC §119(a)-(d) of German Application No. 10 2015 116 352.7 filed Sep. 28, 2015, the entireties of which are incorporated herein by reference.

### FIELD OF THE INVENTION

The present invention relates to a method for providing and handling different components and to a device for providing and handling different components.

### BACKGROUND OF THE INVENTION

DE 10 2012 003 160 A1 discloses a device for providing and handling a quantity of different components, which device comprises a conveying unit, a manipulator and an image system for providing and handling different components.

### SUMMARY OF THE INVENTION

It is an object of the present invention to propose a method and a device for providing and handling different components in which the process reliability is increased.

The method according to the present invention for providing and handling different components comprises the following steps:

projecting at least one image of at least one component from the quantity of the different components onto a surface of a depositing unit or a surface of a conveying unit by means of at least one projector;

depositing manually or by machine, in a manner aligned with the projected image or the projected images, the component defined by the image or the components defined by the images on the surface,

capturing the component deposited on the surface or the components deposited on the surface by means of at least one image capturing unit,

checking the correctness of the position of the component deposited on the surface or of the components deposited on the surface with respect to the projected image or the projected images by means of an image processing unit,

outputting the result or the results of the checking,

if necessary, correcting manually or by machine the position of the incorrectly situated component or of the incorrectly situated components,

if appropriate, renewed checking and renewed outputting and renewed correcting,

gripping and conveying further the correctly situated component or the correctly situated components by means of a manipulator.

This ensures that the different components are provided or fed to the manipulator in a position provided, such that the manipulator can grip and convey further each component reliably and without delay. The method thus makes it possible to provide or feed the components to the manipulator in an error-free position, such that the gripping process can proceed reliably.

Provision is also made, by means of the surface of the conveying unit, for moving at least one component from a first section provided for the depositing into a second section likewise provided for the depositing. As a result, a longer period of time is available for the depositing process.

Furthermore, provision is made, by means of the surface of the conveying unit, for moving at least one component from the section provided for the capturing and/or the capturing and depositing into a section provided for the gripping. As a result, the capturing and gripping processes can be effected without being disturbed by one another.

Provision is made for outputting the result of the checking of a correct position of the component or of the components by means of the projector or the projectors. For this purpose, the existing projector or the existing projectors can be used and the outlay for an additional outputting means can be dispensed with. Alternatively or additionally, provision is nevertheless made for outputting the result of the checking of a correct position of the component or of the components by means of a sound and/or voice output means. This is expedient particularly if the components are placed manually and a worker is intended to be made aware of the requirement of correcting the position of a component.

In the case of optical outputting of the result of the checking, provision is made for choosing a coloration and/or a type of representation of the individual images depending on whether the image processing system identifies that as yet no component is aligned in a manner corresponding to the image or that a component is aligned in a manner corresponding to the image or that a component is aligned in a manner deviating from the image. In particular, provision is made for projecting unoccupied images in a yellow color, for projecting images occupied by a component in a correct position in a green color, and for projecting images occupied incorrectly or unoccupied for an excessively long time in a red color. Furthermore, provision is also made for projecting the images with different types of lines such as, for example, with dashed lines or dotted lines or else, for example, with rapidly or slowly flashing lines. It is thereby possible to display a large amount of information which either can be directly implemented by a worker placing components manually or enables a worker entrusted with monitoring to make a rapid diagnosis.

Furthermore, provision is made for the images of the components to be projected as contours of the components or as plan views of the components or as holograms of the components. It is thereby possible to provide indications in various strong forms for manual placement and/or for monitoring. In this case projecting a contour is sufficient for planar components, and in this case projecting plan views or holograms in the case of geometrically more complex components means a great facilitation for the worker.

Provision is also made for a movement of the surface of the conveying unit by a control system for the projector and the image capturing unit and the image processing unit to be identified either by means of a sensor of a drive of the conveying unit or to be identified by a detection of a simultaneous movement of at least two components situated on the surface of the conveying unit or to be identified by a detection of a code arranged on the surface of the conveying unit and for thereby controlling the projector or the projectors in such a way that the projected image or the projected images is or are moved with the conveying unit or projected at a different position following the movement. It is thereby possible to entrain the projected image or the projected images with the surface of the conveying unit continuously or in a stepwise manner, such that the images are displayed at least with the surface stationary. If the images are entrained synchronously with a movement of the running surface, this affords the advantage that the running surface can also be occupied with components by workers even during its movement. This is particularly advantageous, for example, if a plurality of workers occupy a surface with identical parts in each case and one manipulator or a plurality of manipulators grip(s) the components with the surface moving.

Furthermore, provision is made for projecting indications with the aid of the projector or with the aid of the projectors alongside the surface of the depositing unit or alongside the surface of the conveying unit, wherein the indications are embodied, in particular, in the form of lines or arrows. An assignment of components provided to the images projected onto the surface is thereby facilitated for the workers.

The device according to the present invention for providing and handling a quantity of different components comprises a depositing unit or a conveying unit, a manipulator and an image system, wherein the image system comprises at least one projector, at least one image capturing unit and an image processing unit. It is thereby possible both to monitor an actual state and to represent a SETPOINT state, with the result that it is possible to occupy the conveying unit with components manually and deviations from a SETPOINT state are also discernible to the worker at a glance, with the result that conclusions about the error source are possible without further analysis.

Provision is also made for projecting images of components from the quantity of the different components onto an area portion of a surface of the depositing unit by means of the projector or by means of the projectors. This ensures that the different components can be fed to the manipulator in a position provided, such that the manipulator can grip and convey further each component reliably and without delay. The device thus makes it possible to feed the components to the manipulator in an error-free position, such that the gripping process can proceed reliably.

Finally, provision is made for the projector or the projectors to project images of components from the quantity of the different components onto area portions of a surface of the conveying unit which are adjacent in a conveying direction, and for, upon a further movement of the surface of the conveying unit, the images to be projected in such a way that the images follow the movement of the surface of the conveying unit continuously or in a stepwise manner. This ensures that the different components can be fed to the manipulator in a position provided, such that the manipulator can grip and convey further each component reliably and without delay. The device thus makes it possible to feed the components to the manipulator in an error-free position, such that the gripping process can proceed reliably.

Within the meaning of the invention the position of a component is understood to be the spatial alignment thereof in a state situated on a surface of a conveying unit.

### BRIEF DESCRIPTION OF THE DRAWINGS

Further details of the invention are described on the basis of schematically illustrated exemplary embodiments in the drawing.

FIG. 1 shows a schematic side view of a device according to the present invention for providing and handling a quantity of different components;

FIG. 2 shows a sectional view through the device shown in FIG. 1 in a manner corresponding to the sectional line II-II; and

FIG. 3 shows the section II shown in FIG. 2 in an enlarged view.

### DETAILED DESCRIPTION OF THE INVENTION

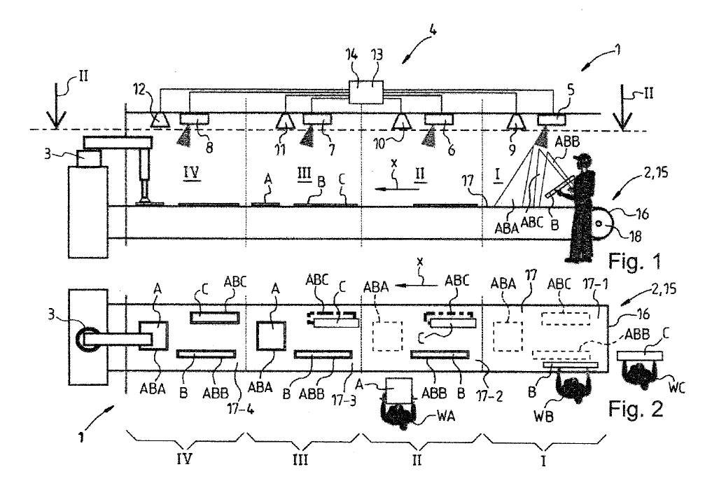

FIG. 1 shows a device 1 according to the present invention for providing and handling a quantity of different components A, B and C in side view. The device is shown once again in FIG. 2 with a view from above cut along the sectional line II-II. The device 1 comprises a conveying unit 2, a manipulator 3 and an image system 4. The image system 4 comprises four projectors 5 to 8 and four image capturing units 9 to 12, which are optionally configured as camera or scanner. Furthermore, the image system 4 comprises an image processing unit 13, which conditions the images of an ACTUAL state captured by the image capturing units 9 to 12 and coordinates them with stored SETPOINT stipulations for the position of the components. The projectors 5 to 8 are controlled by a control system 14, in particular, in a manner corresponding to the results of the image processing, the control system being formed, in particular, by a programmable logic controller. An interface to the conveying unit 2 and the manipulator 3 is also formed by the control system 14.

The conveying unit 2 is configured as a conveyor belt 15 comprising a circulating belt 16, wherein the belt 16 has, toward the image system 4, a surface 17 oriented approximately horizontally in space. In this case, the belt 16 and thus also the surface 17 mentioned are moved by a drive 18 in a stepwise manner in an arrow direction x, such that components A, B and/or C placed onto the surface 17 are moved in a stepwise manner from a first section I via a second section II and a third section III into a fourth section IV. In this case, the first and second sections I, II are provided for the depositing of components by workers WA, WB and WC. The third section III—as already the sectors I and II as well—is provided for a manual final correction. Following this final correction, all the components must be situated correctly. The fourth section IV is provided for the purpose that the components A, B and C fed positionally correctly are gripped by the manipulator 3 and, in a manufacturing cell (not illustrated) assigned to the manipulator 3, are mounted by the manipulator 3 in particular on vehicle bodywork. Such gripping and placing of the components A, B and C is also referred to as handling by the manipulator 3. Since a manipulator works in the fourth section IV, the latter is inaccessible to the workers WA, WB, WC during operation, such that the workers WA, WB and WC can have access to the components and thus make corrections only in sections I to III.

In accordance with an embodiment variant that is not illustrated, provision is also made for one or more further manipulators and optionally also additionally one or more workers to equip the surface of the conveying unit with the required components. In such a configuration, it is necessary, of course, to take account of the safety provisions for the cooperation of workers and manipulators. In the case of such a configuration, provision is also made for the further manipulator(s) to make corrections and to be ordered to do this by the control system.

Each of the sections I to IV is assigned a projector 5 and 6 and 7 and 8, respectively, and an image capturing unit 9 and 10 and 11 and 12, respectively. In this case, the projectors 5 to 8, in their respective section I and II and III and IV, project images ABA, ABB and ABC of the components A to C which are intended to be fed to the manipulator assigned to the section IV for the purpose of handling onto the individual sections I to IV of the surface 17 of the conveying unit 2. The projected images are designated only in the section I in FIG. 1. In the embodiment variant illustrated, the projector 8 and the image capturing unit 12, which are assigned to the section IV, are provided as optional components which—if they are installed—can be used for monitoring and/or analysis purposes. They are not necessary for the work of the workers.

If an occupancy is changed, which is not illustrated in FIGS. 1 to 3, the changed occupancy is firstly projected onto the surface 17 for the first time in the section I, while a previous occupancy is still projected onto the surface 17 in the sections II, III and optionally IV. The sections are monitored in a manner corresponding to the respectively projected occupancy by means of the image capturing unit and the image processing unit.

FIG. 2 shows how three workers WA, WB and WC bring components ABC to the conveying unit 2. In this case, an area portion 17-1 of the surface 17, the area portion being located in the section I, has not yet been occupied by components. Accordingly, the images ABA, ABB, ABC projected onto the area portion 17-1 are represented with dashed contour lines. The area portion 17-2 of the surface 17, the area portion being located in the section II, has already been occupied with components B and C by the workers. In this case, the component B—as is indicated by a continuous contour line used as image ABB—was positioned in a positionally correct manner. By contrast, the component C—as is indicated by a thick, dashed contour line used as image ABC—was identified as incorrectly situated by the image system by means of the image capturing unit 10. As illustrated in FIG. 2, the worker WA is just in the process of subsequently placing one of the components A, which is marked still as absent in the section II by means of an image ABA—dashed contour line. A position correction is still required in the section III or in the area portion 17-3 with respect to the component C situated there. The components A, B and C shown in the section IV or in the area portion 17-4 have all been deposited positionally correctly, the component A currently being gripped by the manipulator 3. A cyclic advance of the surface 17 is enabled by the image system 4, however, only if the component C situated incorrectly in the section III is positioned in a positionally correct manner. It goes without saying that incorrect components are also identified by the image system. In this case, provision is made for the image to which the incorrect component is assigned to be represented in a flashing manner. To facilitate the placement, provision is also made for additionally projecting information, in particular, in the form of text and images and, in particular, also in the form of short films onto the surface 17 in order to support the workers in the correction in the event of an error having been identified or in order to make the workers familiar with changed occupancies.

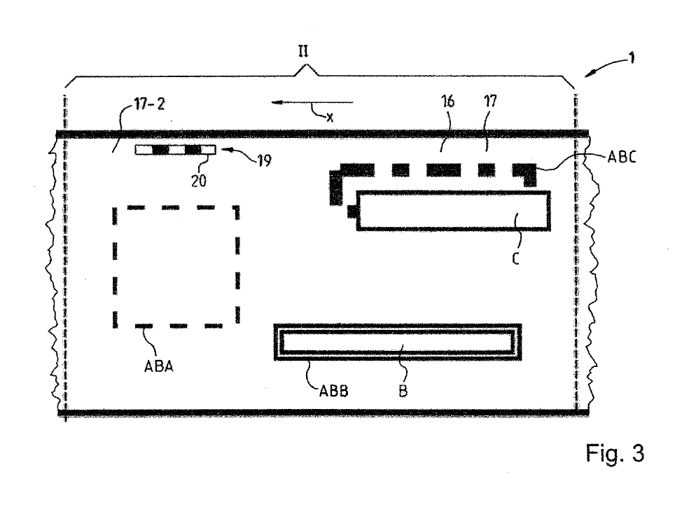

For better discernibility, the section II shown in FIG. 2 is illustrated once again in an enlarged view in FIG. 3, such that the different representation of the images ABA, ABB and ABC is better discernible. Furthermore, in addition to the illustration in FIG. 2, FIG. 3 illustrates a code 19—arranged on the surface 17—in the form of a code strip 20, which moves with the surface 17 or the belt 16. The code strip 20 enables the image system 4 to identify a movement of the surface 17 and to align both the projection of the images ABA, ABB and ABC and the capture of the components A, B, C in each section I-IV in a manner corresponding to the actual movement. In this case, it is not necessary for the conveyor belt 15 to move its belt 16 with high precision. Accordingly, provision is also made for a position which the components A, B and C occupy in space in the section IV to be communicated to the manipulator 3 by the image system, such that tolerances are thereby compensated for at this interface as well.

The illustrations in FIGS. 1 to 3 should be understood as schematic illustration. Provision is made, in particular, for dividing the image processing unit among the individual image capturing units and for using cameras having integrated image processing. Furthermore, provision is also made, in particular, for respectively embodying image capturing unit and projector as a structural unit.

In accordance with an embodiment variant that is not illustrated, the sectors I to III or I to IV are supplied by a single projector and by a single image capturing unit. In this case, provision is also made for the projector also still to perform the below-mentioned projection of indications onto the floor alongside the conveying unit.

In accordance with an embodiment variant that is not illustrated, an entrainment of the projected images with the movement of the surface is provided both in the case of the described stepwise movement of the surface 17 and in the case of a continuous movement of the surface 17. For this purpose, the projection is synchronized with the movement of the surface 17 by the image system 4. In a departure from the exemplary embodiment illustrated, such a projection is performed by only one projector or the projection is performed by a plurality of projectors, the projection areas of which closely adjoin one another or overlap one another in such a way that the images are representable in an uninterrupted manner on the surface. Accordingly, in the case of such an embodiment, provision is then also made, in particular, for the position of the components to be captured by the image capturing unit or the image capturing units during the movement of components. As a result, a longer period of time is available to the image system for the image capture. Furthermore, different perspectives on the individual components are thereby available for the image capture, which afford additional possibilities for position identification.

In accordance with an embodiment variant that is not illustrated, provision is furthermore made for projecting indications for the workers e.g. on the floor alongside the depositing unit or alongside the conveying unit, which indications facilitate the assignment of components provided in magazines alongside the conveying unit to the projections on the surface. The indications are configured, in particular, as lines or arrows which are placed in terms of control engineering such that they specify for the worker an optimum and in particular short path for equipping the conveying unit or the depositing unit, thereby relieving the worker with regard to the latter's workload.

In accordance with an embodiment variant that is not illustrated, provision is also made for using, instead of a conveying unit in which the introduced components are moved from section to section until they are then picked up from the last section by a manipulator and conveyed further, a depositing unit designed as a depositing table onto which a worker supported by an image system arranges components for later access by a manipulator.

### LIST OF REFERENCE SIGNS

1 Device
2 Conveying unit
3 Manipulator
4 Image system
5-8 Projector of 4
9-12 Image capturing unit of 4
13 Image processing unit of 4
14 Control system for 5 to 13
15 Conveyor belt
16 Belt
17 Surface
17-1-17-4 Area portion of the surface
18 Drive
19 Code
20 Code strip
I-IV Section
A-C Component
ABA, ABB, ABC Image of A to B
WA, WB, WC Worker
x Direction of movement of 17

1. A method for providing and handling different components, comprising the following steps:
projecting at least one image of at least one component from the quantity of the different components onto a surface of a depositing unit or a surface of a conveying unit by means of at least one projector;
depositing manually or by machine, in a manner aligned with the projected image or the projected images, the component defined by the image or the components defined by the images on the surface,
capturing the component deposited on the surface or the components deposited on the surface by means of at least one image capturing unit,
checking the correctness of the position of the component deposited on the surface or of the components deposited on the surface with respect to the projected image or the projected images by means of an image processing unit,
outputting the result or the results of the checking,
if necessary, correcting manually or by machine the position of the incorrectly situated component or of the incorrectly situated components,
if appropriate, renewed checking and renewed outputting and renewed correcting,
gripping and conveying further the correctly situated component or the correctly situated components by means of a manipulator.

2. The method as claimed in claim 1, wherein by means of the surface of the conveying unit, at least one component is moved from a first section provided for the depositing into a second section likewise provided for the depositing.

3. The method as claimed in claim 2, wherein by means of the surface of the conveying unit, at least one component is moved from a section provided for the capturing and/or capturing and depositing into a section provided for the gripping.

4. The method as claimed in claim 1, wherein the result of the checking is output by the projector or the projectors.

5. The method as claimed in claim 4, wherein a coloration and/or a type of representation of the individual images are/is chosen depending on whether the image processing system identifies that as yet no component is aligned in a manner corresponding to the image or that a component is aligned in a manner corresponding to the image or that a component is aligned in a manner deviating from the image.

6. The method as claimed in claim 5, wherein the images of the components are projected as contours of the components or as plan views of the components or as holograms of the components.

7. The method as claimed in claim 1, wherein a movement of the surface of the conveying unit by a control system for the projector and the image capturing unit and the image processing unit
is identified either by means of a sensor of a drive of the conveying unit, or
is identified by a detection of a simultaneous movement of at least two components situated on the surface of the conveying unit, or
is identified by a detection of a code arranged on the surface of the conveying unit, and
wherein the projector or the projectors is or are thereby correspondingly controlled in such a way that the projected image or the projected images is or are moved with the conveying unit or projected at a different position following the movement.

8. The method as claimed in claim 1, wherein indications are projected by the projector or by the projectors alongside the surface of the depositing unit or conveying unit, wherein said indications are embodied in particular in the form of lines or arrows.

9. A device for providing and handling a quantity of different components comprising a depositing unit or a conveying unit, a manipulator and an image system, wherein the image system comprises at least one projector, at least one image capturing unit and an image processing unit.

10. The device as claimed in claim 9, wherein the projector or the projectors projects or project images of components from the quantity of the different components onto an area portion of a surface of the depositing unit.

11. The device as claimed in claim 9, wherein the projector or the projectors projects or project images of components from the quantity of the different components onto area portions of a surface of the conveying unit which are adjacent in a conveying direction, and in that upon a further movement of the surface of the conveying unit the images are projected in such a way that the images follow the movement of the surface of the conveying unit continuously or in a stepwise manner.
